(19) United States
(12) Patent Application Publication
(10) Pub. No.: US 2017/0080449 A1
(43) Pub. Date: Mar. 23, 2017

(54) HOT MELT GLUE GUN WITH A BASE

(71) Applicant: HOMEEASE INDUSTRIAL CORPORATION LTD., Chia Yi Hsien (TW)

(72) Inventor: Grace LEE, Chia Yi Hsien (TW)

(21) Appl. No.: 14/862,147

(22) Filed: Sep. 22, 2015

(51) Int. Cl. B05C 17/005

(52) U.S. Cl. CPC B05C 17/0053; B05C 17/0052

(57) ABSTRACT

A hot melt glue gun with a base includes a hot melt glue gun and an auxiliary base detachably mounted to the hot melt glue gun. The hot melt glue gun includes a bottom. The bottom is flat and includes two lateral sides. Each of the two lateral sides of the bottom includes a groove and a coupling groove in communication with the groove.

The auxiliary base includes a base body having a flat bottom and two arms extending from the flat bottom. Each of the two arms includes a coupling block. Each coupling block is detachably coupled with one of the coupling grooves.

### BACKGROUND OF THE INVENTION

The present invention relates to a hot melt glue gun with a base and, more particularly, to a gun-shaped hand tool using electricity to generate high heat for melting a glue stick.

With reference to FIGS. 3 and 4, a conventional hot melt glue gun l′ includes a through-hole 11′ extending from a lateral wall through another lateral wall of the hot melt glue gun 1′. A stand 2′ formed by bending a metal wire includes a bottom section 21′ having a width larger than a width between the two lateral walls of the hot melt glue gun 1′. The stand 2′ further includes two vertical sections 22′ and two horizontal sections 23′. Each horizontal section 23′ extends inwards from an upper end of one of the vertical sections 22′. The horizontal sections 23′ are inserted into the through-hole 11′ of the hot melt glue gun 1′. Thus, the stand 2′ can pivot about a pivotal axis defined by the horizontal sections 23′. As shown in FIG. 3, the bottom section 21′ of the stand 2′ can rest on a face of a desk or a table to support the hot melt glue gun 1′.

However, the width of the bottom section 21′ of the stand 2′ is only slightly larger than the width between the two lateral walls of the hot melt glue gun l′ that has a relatively large height compared to the width, such that the hot melt glue gun l′ tends to topple due to an unstable center of gravity.

### BRIEF SUMMARY OF THE INVENTION

The primary objective of the present invention is to provide a holt melt glue gun with a base to lower the center gravity of the hot melt glue gun, increasing the stability to permit the hot melt glue gun to stand stably.

The hot melt glue gun with a base according to the present invention includes a hot melt glue gun and an auxiliary base detachably mounted to the hot melt glue gun. The hot melt glue gun includes a bottom. The bottom is flat and includes two lateral sides. Each of the two lateral sides of the bottom includes a groove and a coupling groove in communication with the groove. The auxiliary base includes a base body having a flat bottom and two arms extending from the flat bottom. Each of the two arms includes a coupling block. Each coupling block is detachably coupled with one of the coupling grooves.

The present invention will become clearer in light of the following detailed description of illustrative embodiments of this invention described in connection with the drawings.

### DESCRIPTION OF THE DRAWINGS

FIG. 1 is a partly exploded perspective view of a hot melt glue gun with a base according to the present invention.

FIG. 2 is a side view of the hot melt glue gun with a base according to the present invention.

FIG. 3 is a diagrammatic side view of a conventional hot melt glue gun.

FIG. 4 is a side view of a stand of the conventional hot melt glue gun.

### DETAILED DESCRIPTION OF THE INVENTION

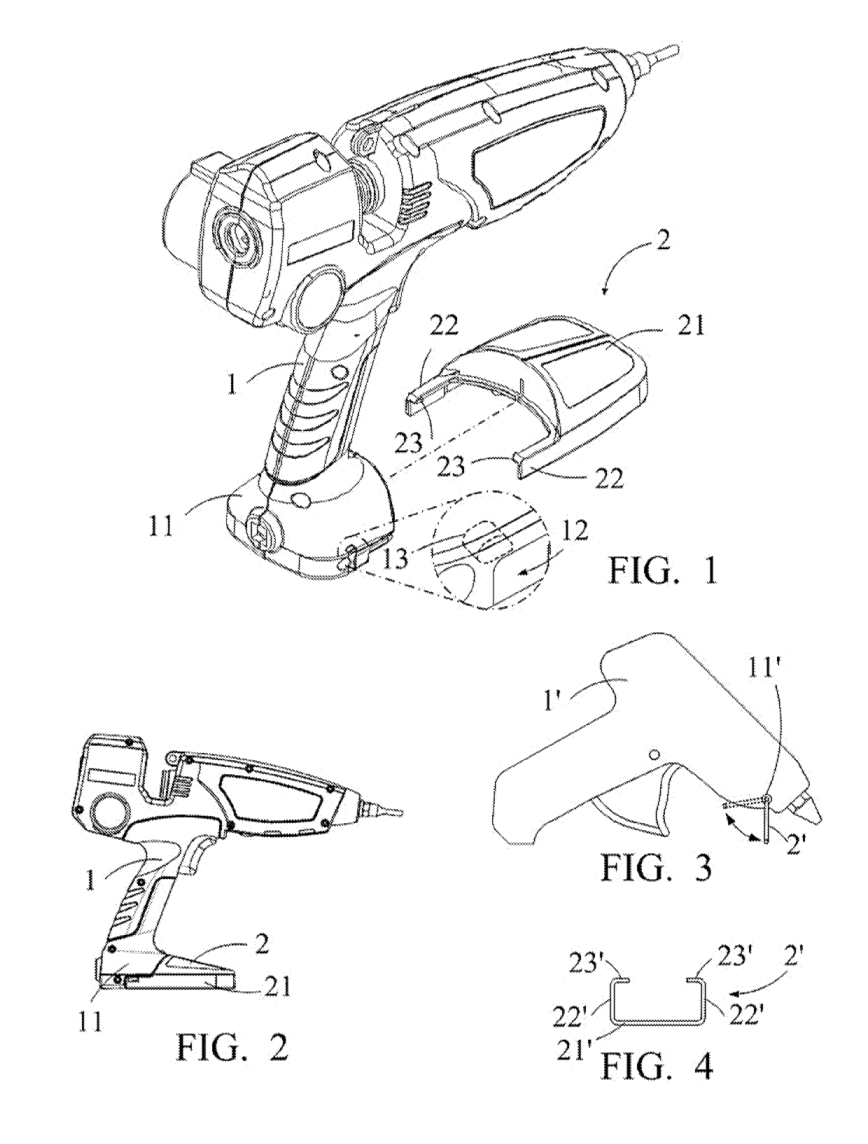

With reference to FIGS. 1 and 2, a hot melt glue gun with a base according to the present invention includes a hot melt glue gun 1 and an auxiliary base 2 detachably mounted to the hot melt glue gun 1.

The hot melt glue gun 1 includes a bottom 11. The bottom 11 is flat and includes two lateral sides. Each of the two lateral sides of the bottom 11 includes a groove 12 and a coupling groove 13 in communication with the groove 12.

The auxiliary base 2 includes a base body 21 having a flat bottom and two arms 22 extending from the flat bottom. Each of the two arms 22 includes a coupling block 23.

Each coupling block 23 is detachably coupled with one of the coupling grooves 13.

When a user intends to make the hot melt glue gun 1 stand reliably, the arms 22 of the auxiliary base 2 are moved into the grooves 12 of the bottom 11, and the coupling blocks 23 of the arms 23 are engaged in the coupling grooves 13. Thus, the auxiliary base 2 is coupled to the bottom 11 of the hot melt glue gun 1 to reliably support the hot melt glue gun 1. When it is desired to use the hot melt glue gun 1, the auxiliary base 2 is detached from the bottom 11 of the hot melt glue gun 1 without using any tool. Thus, the user can easily hold the hot melt glue gun 1 without the weight and the volume of the auxiliary base 2, providing use convenience.

Although specific embodiments have been illustrated and described, numerous modifications and variations are still possible without departing from the scope of the invention. The scope of the invention is limited by the accompanying claims.

1. A hot melt glue gun with a base, comprising a hot melt glue gun and an auxiliary base detachably mounted to the hot melt glue gun, with the hot melt glue gun including a bottom, with the bottom being flat and including two lateral sides, with each of the two lateral sides of the bottom including a groove and a coupling groove in communication with the groove, with the auxiliary base including a base body having a flat bottom and two arms extending from the flat bottom, with each of the two arms including a coupling block, and with each coupling block detachably coupled with one of the coupling grooves.
